(19) United States
(12) Patent Application Publication
(10) Pub. No.: US 2013/0246310 A1
(43) Pub. Date: Sep. 19, 2013

(54) SYSTEMS AND METHODS FOR PROVIDING AN ONLINE PRIVATE CAPITAL MARKETPLACE

(71) Applicants: Michael Paul Weiss, Gig Harbor, WA (US); Sidney C. Porter, Poulsbo, WA (US)

(72) Inventors: Michael Paul Weiss, Gig Harbor, WA (US); Sidney C. Porter, Poulsbo, WA (US)

(21) Appl. No.: 13/543,766

(22) Filed: Jul. 6, 2012

Related U.S. Application Data
(60) Provisional application No. 61/610,261, filed on Mar. 13, 2012.

(51) Int. Cl. G06Q 40/06

(52) U.S. Cl. 705/36 T

(57) ABSTRACT

A system for issuing a hybrid structured preferred security within private capital markets, comprising an application server computer, a data analysis manager, a due diligence manager, a pricing manager, a transaction manager, and a plurality of data collection servers adapted to retrieve remote electronic tax data from a taxing authority. Upon receiving a request from an entity for a capital transaction, the application server receives a plurality of data elements pertaining to the entity. An automated due diligence process is conducted using tax data from the entity. The data analysis manager computes risk parameters pertaining to the transaction. The pricing manager computes deal parameters. On receiving from an investor an acceptance of a deal, the transaction manager issues hybrid securities comprising preferred equity shares and warrants to convert preferred equity shares into common shares.

### CROSS-REFERENCE TO RELATED APPLICATIONS

This application claims priority to U.S. provisional patent application, Ser. No. 61/610,261, titled “SYSTEM AND METHOD FOR ISSUING A HYBRID STRUCTURED PREFERRED SECURITY”, which was filed on Mar. 13, 2012, the specification of which is incorporated herewith in its entirety.

### BACKGROUND OF THE INVENTION

1. Field of the Invention

The invention relates to the field of private capital markets, and more particularly to the field of automated online marketplaces for efficiently conducting private capital market transactions.

2. Discussion of the State of the Art

Private capital markets face unique challenges, particularly as compared to public equity markets. Since private capital markets deal inherently with investment transactions involving privately held companies, investors do not generally have access to anything like the wide range of information available to them when evaluating publicly held companies. Moreover, while some privately held companies financed using private capital markets are quite large, a large number of private company investment transactions occur that involve small private companies. These companies not only do not share important financial information, but they often do not have the degree of detail and the extent of historical financial data typical of large private companies. Because of this, it is usually difficult for a potential investor to confidently assess small private companies' value, or to gauge the risks they might take if they were to invest in such companies.

Additionally, even without the dramatic difference in information quality and quantity that exists between public companies and private companies, and especially small private companies, investors in small private companies take on significant systemic risks. Small private company equity and debt instruments (e.g., stocks and bonds, and the like) are often quite illiquid, making it difficult for investors to exit their investments quickly if trouble develops. One general approach used to minimize overall investment (or lending) risk is diversification, but diversification is also difficult for investors in small private companies. This is because the cost of performing necessary due diligence for investment transactions does not typically scale linearly with transaction size. Since it generally takes many more investments in small private companies (on average) to build a diversified portfolio in order to spread risk among a number of assets (companies), the cost of building diversified (i.e., risk-mitigated) portfolios of small privately held companies can be prohibitive. Since many transactions are needed, there is a high cost penalty when investing in smaller privately held companies, making them unattractive to large investors.

Another significant problem with small company private capital financing is the strongly divergent needs and attitudes of company owners (typically entrepreneurs) and investors (typically high net worth individuals and professional money managers). While differences between investors' expectations and desires and owners' expectations and desires exist in every market, they are exacerbated in the small private company sector by the fact that most small company owners are not sophisticated business people with experience in capital transactions. By contrast, when a large company looks to raise capital to finance growth or inventory, the work of preparing the necessary investment offering is typically carried out by a chief financial officer who is a finance professional that understands how capital markets work. On the other hand, when small companies look to raise money, the work is generally done by the owner or a managing partner, and very commonly there is no chief financial officer or any other professional finance staff beyond a bookkeeper. The disparity in experience and familiarity with capital transactions is a significant factor in making small company private capitalization a highly risky affair, quite beyond the normal disparity of interests between a buyer and a seller. Moreover, while the financial records of large companies are typically audited by large accounting firms and scrutinized by many entities, those of small private companies usually are not audited and are available only to a small set of owners; thus the quality and truthfulness of financial data provided by small company owners is something that investors have to consider carefully (making this one of the prime drivers for the fact that small company capital transactions are intrinsically risky).

Because of these constraints, historically private capital transactions have been more difficult and expensive to carry out for smaller privately held companies, inhibiting growth opportunities. At the same time, investors constantly seek productive opportunities to invest their assets in growing companies, and a disproportionately large number of high-growth companies tend to be smaller, privately held companies. While some classes of smaller growth companies have been well served by the venture capital industry, there are many others who seek financing from long-term, knowledgeable investors to finance their growth and who are frustrated in their search for these investors because of the lack of scalable means to match investors and entrepreneurs.

What is needed is a system and various methods for efficiently carrying out small private company capital financing transactions. To function efficiently in a scalable manner requires techniques for automating significant portions of the financing process, and particularly due diligence processes, to reduce the cost of these transactions and thereby to facilitate investors' pursuit of portfolio diversification. Furthermore, such a system requires a subsystem for automatically generating valuation options for privately held companies, and particularly for generating estimates bridging the difference between a seller's (owner's) perspective and a buyer's (investor's) perspective, in order to facilitate transactions.

### SUMMARY OF THE INVENTION

Accordingly, the inventor has conceived, and reduced to practice, various systems and methods for providing an online private capital marketplace.

In a preferred embodiment of the invention, a system for issuing a hybrid structured preferred security within private capital markets is disclosed, comprising an application server computer connected to a data network, a data storage subsystem coupled to the application server, a data analysis manager software module operating on a server computer and coupled to an analytics database, an automated due diligence manager software module operating on a server computer, an automated pricing manager software module operating on a server computer, a transaction manager software module operating on a server computer, and a plurality of data collection servers adapted to retrieve via the Internet financial data pertaining to a prospective capital transaction from a plurality of remote data sources comprising at least a remote electronic tax data retrieval system operated by a taxing authority. According to the embodiment, upon receipt by the application server of a request for initiation of a new prospective capital transaction by an entity seeking investment, the application server sends a plurality of data entry forms to the entity and receives as a result a plurality of data elements pertaining to the entity or the prospective capital transaction and an automated due diligence process is conducted by the automated due diligence manager using at least tax data retrieved from at least one remote electronic tax data retrieval system. Using a plurality of results from the automated due diligence process and a plurality of analyses of historical data pertaining to other entities and their capital transactions, the data analysis manager computes one or more risk parameters pertaining to the prospective capital transaction. The automated pricing manager computes, a plurality of deal parameters comprising one or more of an interest rate for a preferred equity, a conversion ratio for a warrant, a maturity date for conversion of the warrant, and a share price of the preferred equity. The application server sends the plurality of deal parameters to the requesting entity, receives an indicia of acceptance of the plurality of deal parameters from the requesting entity, and thereupon makes the plurality of deal parameters available for review by a plurality of potential investors via the Internet. On receiving from an investor an acceptance of a plurality of final deal parameters and an amount to be invested, the transaction manager verifies that the final deal parameters satisfy one or more constraints provided by the requesting entity, and if the verification is successful issues a plurality of hybrid securities to the investor equivalent to the amount to be invested, each hybrid security comprising a preferred equity share with an interest rate and a detachable warrant to convert the preferred share into a number of common shares at any time after a specific maturity date, the number of common shares determined by a specific conversion ratio.

According to another preferred embodiment of the invention, a method for issuing a hybrid structured preferred security within private capital markets is disclosed, the method comprising the steps of: (a) receiving, at an application server, a request for initiation of a new prospective capital transaction by an entity seeking investment; (b) sending, by the application server, a plurality of data entry forms to the entity; (c) receiving, at the application server, a plurality of data elements pertaining to the entity or the prospective capital transaction; (d) conducting an automated due diligence process by an automated due diligence manager using at least tax data retrieved from at least one remote electronic tax data retrieval system; (e) computing, using a data analysis manager software module, one or more risk parameters pertaining to the prospective capital transaction using a plurality of results from the automated due diligence process and a plurality of analyses of historical data pertaining to other entities and their capital transactions; (f) computing, using an automated pricing manager software module, a plurality of deal parameters comprising one or more of an interest rate for a preferred equity, a conversion ratio for a warrant, a maturity date for conversion of the warrant, and a share price of the preferred equity; (g) sending the plurality of deal parameters to the entity; (h) receiving an indicia of acceptance of the plurality of deal parameters from the entity; (i) making the plurality of deal parameters available for review by a plurality of potential investors via the Internet; (j) receiving from an investor an acceptance of a plurality of final deal parameters and an amount to be invested; and (k) upon verification by a transaction manager software module that the final deal parameters satisfy one or more constraints provided by the requesting entity, issuing a plurality of hybrid securities to the investor equivalent to the amount to be invested, each hybrid security comprising a preferred equity share with an interest rate and a detachable warrant to convert the preferred share into a number of common shares at any time after a specific maturity date, the number of common shares determined by a specific conversion ratio.

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a block diagram illustrating a hardware architecture of a computing device used in various embodiments of the invention.

FIG. 2 is a block diagram illustrating an exemplary logical architecture for a client device, according to various embodiments of the invention.

FIG. 3 is a block diagram illustrating an exemplary architectural arrangement of clients, servers, and external services, according to various embodiments of the invention.

FIG. 4 is a block diagram of a system for providing an online private capital marketplace, according to a preferred embodiment of the invention.

FIG. 5 is a process flow diagram illustrating a method for automatically performing some part of a due diligence process in support of a private investment transaction, according to a preferred embodiment of the invention.

FIG. 6 is a process flow diagram illustrating an overall private company investment process from the perspective of an owner, according to an embodiment of the invention.

FIG. 7 is a process flow diagram illustrating an automated business valuation process, according to an embodiment of the invention.

FIG. 8 is a process flow diagram illustrating a process for creating a hybrid security for private capital transactions, according to an embodiment of the invention.

FIG. 9 is process flow diagram illustrating an overall private company investment process from the perspective of an investor, according to an embodiment of the invention.

FIG. 10 is a process flow diagram illustrating a process for portfolio diversification using fractionalized lending, according to an embodiment of the invention.

### DETAILED DESCRIPTION

The inventor has conceived, and reduced to practice, a system and method for issuing a hybrid structured preferred security within private capital markets. Various techniques will now be described in detail with reference to a few example embodiments thereof, as illustrated in the accompanying drawings. In the following description, numerous specific details are set forth in order to provide a thorough understanding of one or more aspects and/or features described or referenced herein. However, it will be apparent to one skilled in the art, that one or more aspects and/or features described or referenced herein may be practiced without some or all of these specific details. In other instances, well known process steps and/or structures have not been described in detail in order to not obscure some of the aspects and/or features described or reference herein.

One or more different inventions may be described in the present application. Further, for one or more of the inventions described herein, numerous alternative embodiments may be described; it should be understood that these are presented for illustrative purposes only. The described embodiments are not intended to be limiting in any sense. One or more of the inventions may be widely applicable to numerous embodiments, as is readily apparent from the disclosure. In general, embodiments are described in sufficient detail to enable those skilled in the art to practice one or more of the inventions, and it is to be understood that other embodiments may be utilized and that structural, logical, software, electrical and other changes may be made without departing from the scope of the particular inventions. Accordingly, those skilled in the art will recognize that one or more of the inventions may be practiced with various modifications and alterations. Particular features of one or more of the inventions may be described with reference to one or more particular embodiments or figures that form a part of the present disclosure, and in which are shown, by way of illustration, specific embodiments of one or more of the inventions. It should be understood, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described, it will be readily apparent that more than one device or article may be used in place of a single device or article. Similarly, where more than one device or article is described, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be noted that particular embodiments include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

A “database” or “data storage subsystem” (these terms may be considered substantially synonymous), as used herein, is a system adapted for the long-term storage, indexing, and retrieval of data, the retrieval typically being via some sort of querying interface or language. “Database” may be used to refer to relational database management systems known in the art, but should not be considered to be limited to such systems. Many alternative database or data storage system technologies have been, and indeed are being, introduced in the art, including but not limited to distributed non-relational data storage systems such as Hadoop, column-oriented databases, in-memory databases, and the like. While various embodiments may preferentially employ one or another of the various data storage subsystems available in the art (or available in the future), the invention should not be construed to be so limited, as any data storage architecture may be used according to the embodiments. Similarly, while in some cases one or more particular data storage needs are described as being satisfied by separate components (for example, an expanded private capital markets database and a configuration database), these descriptions refer to functional uses of data storage systems and do not refer to their physical architecture. For instance, any group of data storage systems of databases referred to herein may be included together in a single database management system operating on a single machine, or they may be included in a single database management system operating on a cluster of machines as is known in the art. Similarly, any single database (such as an expanded private capital markets database) may be implemented on a single machine, on a set of machines using clustering technology, on several machines connected by one or more messaging systems known in the art, or in a master/slave arrangement common in the art. These examples should make clear that no particular architectural approaches to database management is preferred according to the invention, and choice of data storage technology is at the discretion of each implementer, without departing from the scope of the invention as claimed.

Similarly, preferred embodiments of the invention are described in terms of a web-based implementation, including components such as web servers and web application servers. However, such components are merely exemplary of a means for providing services over a large-scale public data network such as the Internet, and other implementation choices may be made without departing from the scope of the invention. For instance, while embodiments described herein deliver their services using web services accessed via one or more webs servers that in turn interact with one or more applications hosted on application servers, other approaches such as peer-to-peer networking, direct client-server integration using the Internet as a communication means between clients and servers, or use of mobile applications interacting over a mobile data network with a one or more dedicated servers are all possible within the scope of the invention. Accordingly, all references to web services, web servers, application servers, and an Internet should be taken as exemplary rather than limiting, as the inventive concept is not tied to these particular implementation choices.

“Structured financial products” are financial instruments issued and sold to investors for various capital raising activities of such entities or its clients.

As used herein, traditional and convertible “preferred stocks” are fixed income securities issued by a private or public corporation and possessing characteristics of both debt and equity. Preferred securities rank above common stock but below subordinated debt and will typically pay a fixed coupon rate. Convertible preferred stocks are paired with one or more warrants, according to the terms of which an investor may convert his preferred stock into common stock. Typically conversion rates (ratio of common to preferred stock that is used during conversion) and conversion maturities (date before which conversions cannot be made) are specified as parameters of the warrants. In some cases, a “detachable warrant” is used, which is a warrant to buy a fixed number of common shares at a fixed price in the future (typically after a maturity date; in effect a detachable warrant is analogous to a call option), which can be detached from the preferred equity share and traded separately.

As used herein, “fundamental economic value” (“FEV”) refers to the value of a company determined by its historical, current, and future economic performance, excluding buyer specific factors and averaging as much as possible the complex set of other factors affecting a potential market value sale. FEV excludes factors such as strategic/synergistic value and is derived by a process that analyzes large amounts of data to average other factors. Examples of averaged factors would include risks of adverse impacts resulting from emergence of new competitors, technology shifts, changes in industry outlook, new government regulations, short-term market volatility, and the like. According to the invention, FEV is used to provide an objective, data driven, stable valuation that captures a company's real value for purposes of fractionalized lending from many investors, typically involving a hybrid security. Valuation processes of the invention derive a value which serves the interests of both investors and companies. Such processes are ideally automatable, repeatable, stable over time, and perceived as reasonable by all parties—without requiring intense negotiations between buyer and seller

FEV can be understood best by contrasting it with the notion of “fair market value” (or “FMV”), which is defined in U.S. Treasury Regulation§20.2031-1(b) as “The price at which the property would change hands between a willing buyer and a willing seller, when the former is not under compulsion to buy and the latter is not under compulsion to sell, both parties having reasonable knowledge of relevant facts.” Considering this definition and that for FEV provided above, several points are relevant:
As opposed to FMV, FEV utilizes only a key subset of relevant facts. The information utilized is limited to information retrieved from a streamlined automated due diligence process (described in detail herein). Other relevant facts will generally not be available to online systems when dealing with small private company transactions.
FMV anticipates a single buying and selling entity, while FEV is suitable for multiple investors who do not, in general, have the potential to derive value from many considerations available to a single entity.
Unlike FMV, FEV can be applied to investments that do not normally include a change of control or management structure of the company.
Finally, FMV is intrinsically subjective. Different appraisers will often come to markedly different FMV valuations. FEV is objective and repeatable, and hence can be used to provide company valuations over time suitable for “measuring upside” in hybrid security instruments similar to warrants or preferred stock.

As used herein, “strategic investment value” (“SIV”) means a component of the overall value of a company that is based on strategic and/or synergistic considerations of one or more interested parties. For example, a company whose product line might make an important addition to an acquirer's product line would be more valuable to that company than to a general, disinterested investor (who would typically value the company only based on its FEV). The difference between what a strategically motivated acquirer or investor would pay for shares in a company, and what a disinterested investor would pay, is the SIV. Therefore, for all companies, total value can be considered to be primarily determined by FEV+SIV, and for disinterested investors (those without any non-financial, strategic interest in the success or failure of the company being valued), the SIV would typically be identically zero.

As used herein, “fractionalized lending” refers to a debt-based capital transaction where many investors provide capital to a company, each investor lending a fraction of the total loan amount to the borrower.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be disclosed herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, and the like), a consumer electronic device, a music player, or any other suitable electronic device, router, switch, or the like, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or the like).

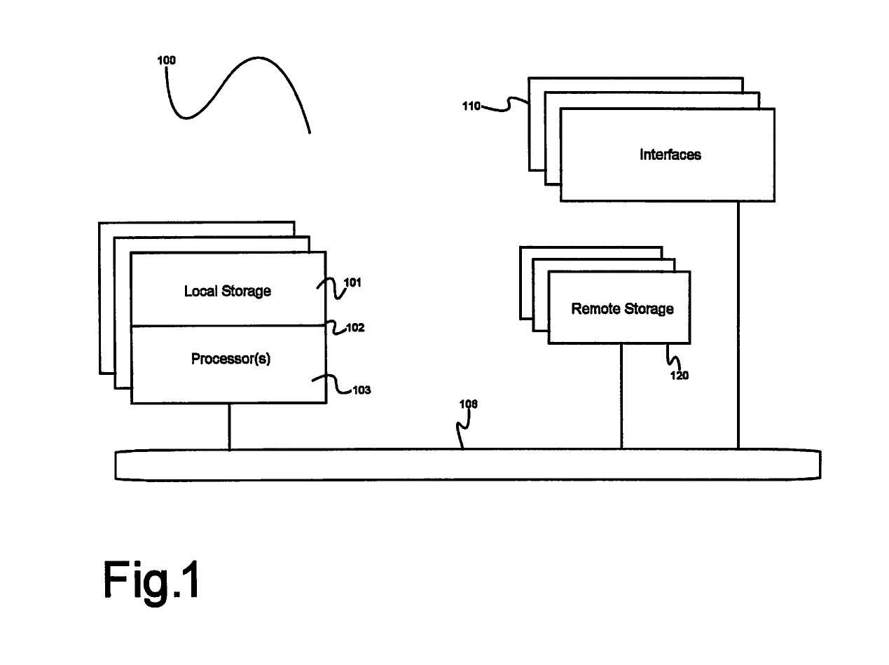

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, Firewire™, PCI, parallel, radio frequency (RF), Bluetooth™, near-field communications (e.g., using near-field magnetics), 802.11 (WiFi), frame relay, TCP/IP, ISDN, fast Ethernet interfaces, Gigabit Ethernet interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include ports appropriate for communication with appropriate media. In some cases, they may also include an independent processor and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine- readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory, solid state drives, memristor memory, random access memory (RAM), and the like. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

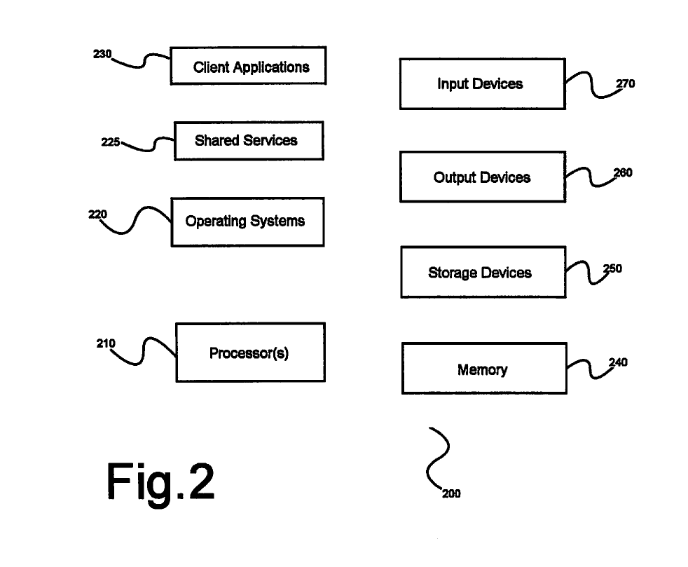

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's Windows™ operating system, Apple's Mac OS/X or iOS operating systems, some variety of the Linux operating system, Google's Android™ operating system, or the like. In many cases, one or more shared services 225 may be operable in system 200, and may be useful for providing common services to client applications 230. Services 225 may for example be Windows™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form. Examples of storage devices 250 include flash memory, magnetic hard drive, CD-ROM, and/or the like.

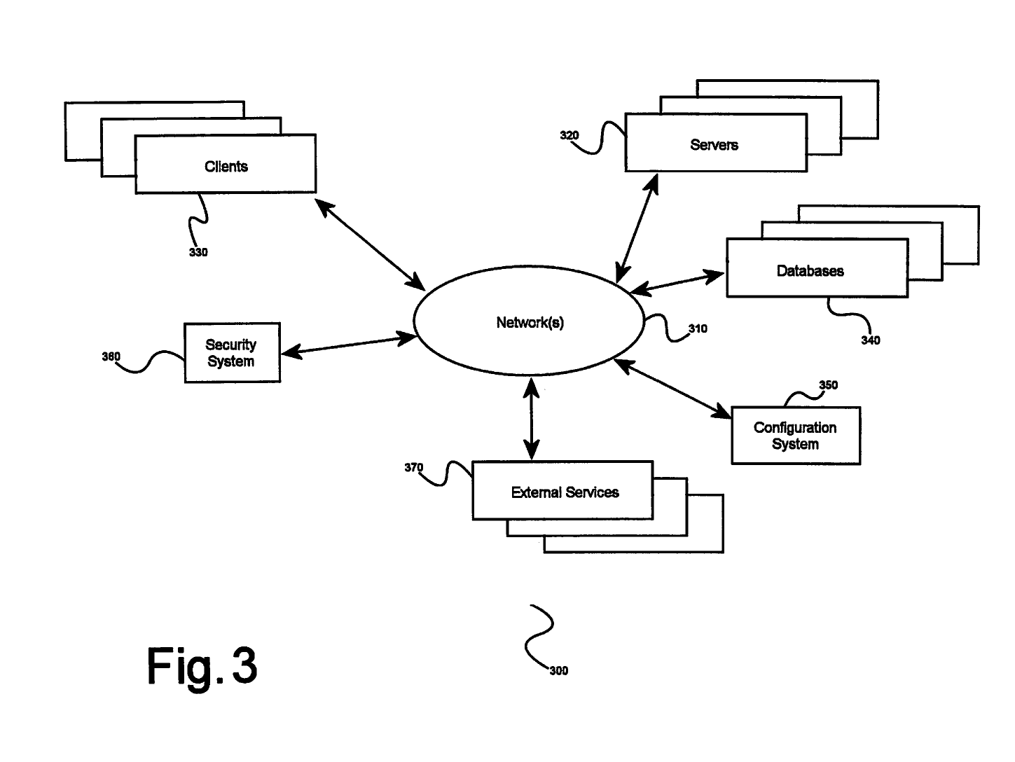

In some embodiments, systems of the present invention may be implemented on a distributed computing network, such as one having any number of clients and/or servers. Referring now to FIG. 3, there is shown a block diagram depicting an exemplary architecture for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments of the Internet, a wide area network, a mobile telephony network, a wireless network (such as WiFi, Wimax, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop, MapReduce, BigTable, and so forth). In some embodiments variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration 350 system or approach is specifically required by the description of any specific embodiment.

In various embodiments, functionality for implementing systems or methods of the present invention may be distributed among any number of client and/or server components. For example, various software modules may be implemented for performing various functions in connection with the present invention, and such modules can be variously implemented to run on server and/or client components.

### Description of System Architecture

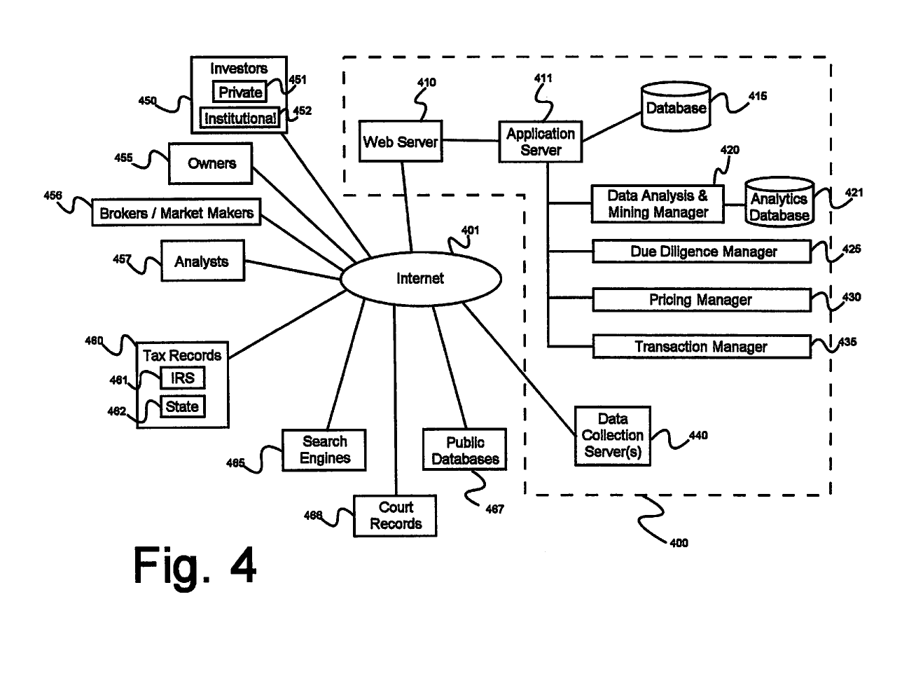

FIG. 4 is a block diagram illustrating exemplary architecture of a system 400 for conducting an online private capital marketplace, according to a preferred embodiment of the invention. According to the embodiment, users access system 400 via Internet 401 or an equivalent network (or in some embodiments via a plurality of networks such as Internet 401), via web server 410. Web server 410 may be any of the many well-known web server types known in the art, for example Microsoft Internet Information Server, Apache Web Server, IBM WebSphere Server, and so forth. It will be appreciated by one having ordinary skill in the art that any web server capable of receiving standard web interaction requests (typically but not necessarily made using hypertext transfer protocol HTTP or equivalent standard protocols) and serving web content to the requestor may be used according to the invention. And, as mentioned above, the use of a web-based architecture herein is merely exemplary, as the novelty of what is claimed is not dependent on any particular data exchange architecture between users and system 400. As is typical in modern web-based applications, web server 410 passes application-specific requests to one or more application servers 411, which again may be of any type known in the art. In turn, application server 411 typically obtains and stores persistent data used by a web application from and to database 415, respectively. As noted above, database 415 may be of any type known in the art, and may be deployed as a single dedicated database server, a logically clustered database server distributed across multiple physical machines, or a particular set of database tables within a general-purpose database management system. As with web server 410, application server 411 and database 415 are exemplary components of system 400, and either or both may be omitted and the logical functions carried out by them in the exemplary architecture of system 400 carried out by other components. For example, configuration data might be stored in a distributed configuration management system, and application-specific data might be stored in the memory of application server 411 rather than in a separate database 415. It will be appreciated by one having ordinary skill in the art that the combination of one or more web servers 410, one or more application servers 411, and one or more databases 415 make up a typical web application architecture, that they represent herein an exemplary approach to implementing the claimed invention, and that they are not limiting in any sense.

According to various embodiments of the invention, various types of users interact with system 400 in order to manage or to participate in an online capital marketplace provided according to the invention. Owners 455 of privately held companies may use system 400 as a means to obtain financing for their companies. Investors 450, whether individual investors 451 or institutional investors 452 (for instance, pension funds, university endowments, mutual funds, and so forth), interact with system 400 to evaluate and possibly make investments in private companies by using the online capital marketplace provided by system 400. Brokers and market makers 456 may interact with system 400 to enable them to actively participate in an online capital marketplace; that is, using system 400, brokers and market makers 456 may carry out the range of investment-related activities which they are known to carry out in the art. In some embodiments of the invention, analysts 457 interact with system 400 to obtain data about potential capital transactions, actual capital transactions, and past capital transactions—and their subsequent performance—carried out using the online capital marketplace of system 400 (or, of course, to obtain data about companies engaging in potential or actual capital transactions using system 400. It should be noted that investors 450, owners 455, brokers and market makers 456, and analysts 457 may not only obtain information from and carry out actions via system 400, but may also be information sources to system 400. For example, analysts' 457 reports regarding privately held companies and the industry segments in which they participate may be obtained by system 400 to facilitate automated due diligence or business valuation. And in particular, both owners and investors are active providers of information to system 400 as well as users of system 400, as will be discussed below.

In addition to users, a wide variety of data sources may be accessed via Internet 401 by system 400, for example to facilitate automated due diligence and business valuation activities of the online capital marketplace of system 400. For example, tax records 460 are an important source of financial data regarding privately held companies and their owners 455. Tax records 460 may be obtained from the Federal Internal Revenue Service (IRS) 461 or from one or more state agencies 462, or indeed from any taxing entities (or tax data storage entities) accessible via public networks such as the Internet 301. Indeed, in some embodiments, proprietary or closed tax data sources 460 may be accessed by system 400 to obtain data that is not freely available but that might be useful in conducting operations such as automated due diligence and business valuation using system 400. Search engines 465, whether general purpose search engines such as Google™ or specialized search engines such as those provided by various providers of social or professional networking applications (such as LinkedIn™ or Facebook™), may be used by system 400 to obtain data that may be relevant to one or more private companies being served by the online capital marketplace of system 400. Similarly, many federal, state, and local governments provide access to court records 466 via Internet-accessible web services, and any or all of these may be used as data sources by system 400, for example to search for court records pertaining to litigation that might materially affect the business prospects or valuation of one or more companies served by the online capital marketplace of system 400. In addition to publicly-available court records (such as the federal courts' Pacer system), commercial legal database may also be used by system 400 for analogous reasons (e.g., Westlaw™, LexisNexis™, Bloomberg Law™, and so forth). Finally, in general any public databases 467 accessible over the Internet 401 may be used as data sources by system 400, according to the invention.

In general, data sources such as those just described are accessed by one or more data collection server 440 within system 400. Data collection servers 440 may, like databases, be comprise a plurality of logical components operating on a single physical machine (in fact, the whole of system 400 may, in some embodiments, operate on a single general-purpose or specialized computing device), or they may comprise a plurality of physically distinct components of system 400. It will be understood by one having ordinary skill in the art that it is the logical functions of data collection servers 440 and the other specialized components of system 400 that are important to understanding the invention; various physical arrangements of the logical components shown in FIG. 4 are contemplated by the inventor and it will be apparent to those having ordinary skill in the art that any physical arrangement that supports the logical relationships described herein may be used without departing from the scope of the invention. In some embodiments, data collection servers 440 may access various data sources over Internet 401 using web server 410 or application server 411 as intermediaries; in other embodiments, one or more data collection servers 440 may access data sources directly over Internet 401 using various interprocess communications techniques known in the art such as Java remote procedure calls (RPC) and the like.

According to the preferred embodiment shown in FIG. 4, several specialized logical components are present in system 400. Data analysis and mining manager 420 performs a variety of data analysis and data mining functions in support of online capital marketplace, using analytics database 421 (which may in some embodiments be co-resident with database 415). Analysis functions comprise, for example, ongoing analysis of historical data regarding capital transactions engaged in by companies, whether using system 400 or other means (for example, public capital transactions such as initial public offerings, mergers and acquisitions of publicly traded companies, stock buybacks and dividend announcements, publicly reported private company transactions such as, for example, private equity acquisitions of publicly traded companies, and the like). Data regarding capital transactions that have occurred in the past are analyzed to identify potential trends or relationships between key variables that may be observable within system 400. For instance, in some embodiments data analysis and mining manager 420 may carry out analyses of large volumes of investment transactions across many industry segments, time periods, and transaction types, in order to derive mathematical relationships between financial indicators such as debt-to-equity ratios, revenue growth rates, profitability, and the like, the mathematical relationships being useful for generating automated business valuations by computing a business value using the relationships (applied to data collected from the various data sources described above). In another exemplary embodiment, data analysis and mining manager 420 may compute one or more risk indexes, or risk profiles, for a particular company or transaction. This may be done either before a transaction occurs, for example to assist potential investors to assess a potential transaction or to generated an automated business valuation, or after a transaction occurs, for example to assess the degree to which a particular investment's risk profile has changed materially since the investment was executed. In general, data analysis and mining manager 420 serves as a central point for value-added analyses in support of the operation of an online capital marketplace using system 400; it will be appreciated by one having ordinary skill in the art of financial data analytics that many possible analytical techniques are known in the art, any of which may be used within data analysis and mining manager 420 without departing from the scope of the invention.

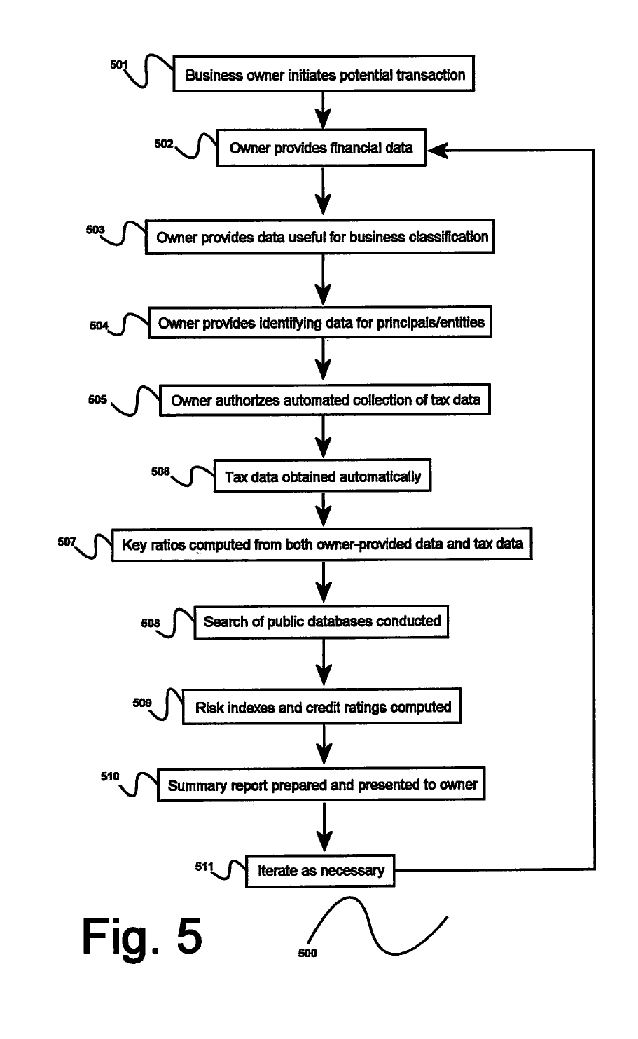

Due diligence manager 425 is a software component that carries out an automated due diligence process (described in more detail below with reference to FIG. 5. As mentioned above, one of the key problems in facilitating capital investment transactions involving small private companies is the fact that due diligence costs tend not to scale linearly with transaction size, so for small transactions the cost of due diligence can materially and adversely impact the likelihood of successful transaction execution. From an owner's perspective, supporting due diligence requirements from investors may be a burden (particularly when there is more than one investor, each of which might insist on different or independent due diligence efforts). From an investor's perspective, the cost of performing due diligence is not appreciably smaller for a small investment transaction than it is for larger transactions, so for a given overall amount of capital that an investor wishes to invest, it is usually far more attractive to invest in one or a few large deals than in a multitude of small deals. Because of these issues, the ability to automatically perform due diligence, and to automatically assess “how much is enough”, are very important aspects of the present invention. According to an embodiment, due diligence manager 425 may estimate the returns—generally in terms of reduction of transaction risk—that can be achieved via a particular due diligence investment. That is, due diligence manager 425 may automatically determine, potentially using data analysis and mining server 420 to carry out related analyses, what due diligence steps that may be automatically performed are needed to achieve a given overall investment risk level.

Pricing manager 430 is a software module that carries out pricing computations according to various methods outlined below for pricing investment transactions. Generally, in private capital transaction, pricing is a difficult task because not only is the value of a private company something about which reasonable people will readily disagree, but also because pricing for a private company must also reflect the risks inherent in such a transaction, whether they stem from company-specific, segment-specific, or economy-wide risk factors. As discussed before, arriving at a price (and hence at a business valuation) that is satisfactory to both a prospective investor and to any relevant stakeholders with an interest in the company is generally very challenging (and is all the more so for small private companies). In fact, if the only variable available for manipulation were a bottom-line price, then small private company capital investments would be very rare, and in fact that is the case in the art today (relative to, for example, investments in large private companies or public companies, for which a wide range of information is readily available to prospective investors). To alleviate this constraint on small private company investment, a variety of price-related parameters are manipulated together to facilitate a “meeting of the minds” between investors (who want good returns with low risk) and owners (who want access to capital without losing control of their companies). For example, in a preferred embodiment of the invention, a combination of interest rate paid on preferred shares, share price for preferred shares, conversion ratio for warrants (the ratio of shares of common stock obtained per share of preferred stock obtained when a warrant is converted), and conversion maturity for warrants (a date before which execution of a warrant to convert preferred shares into common shares at a specific conversion ratio), is used to develop an overall “price” that is satisfactory to investors and to owners. In some embodiments, an aggregate price index is developed based on parameters such as interest rate, share price, warrant conversion ratio, and warrant conversion maturity, in order to allow an online capital marketplace to accept a constraint from an owner in terms of this aggregate price index, and to allow one or more investors to vary one or more of the parameters as desired to align the total risk profile and returns to their investment strategy. According to such embodiments, changes proposed by investors will be accepted if they result in an aggregate price index that remains consistent with any constraints made by the relevant company owners.

According to a preferred embodiment of the invention, transaction manager 435 is a software module that manages the overall investment process. In general, analysis is performed continuously with system 400 on historical and new data, and due diligence and pricing are carried out during the early stages of each prospective investment opportunity where investors can lend money to a private company. On the other hand, as investors view and assess a proposed investment opportunity (which happens after due diligence has been performed by due diligence manager 425 and after the investment has been priced by system 400, using pricing manager 430), they may commit to invest and thereby become contractually bound to lend money as their payment for the preferred shares and warrants; at the same point, the owner becomes bound to make periodic interest payments and to issue the applicable preferred shares and warrants. This process of investment commitment and the steps that follow from it (payments of investment funds, issuance of shares, monthly payments by companies, and possibly conversions of warrants) are managed by transaction manager 435.

### Description of Method Embodiments

FIG. 5 is a process flow diagram illustrating a method for automatically performing some part of a due diligence process 500 in support of a private investment transaction, according to a preferred embodiment of the invention. In general, the method is initiated by an owner, manager, or agent of a company who seeks to raise capital from one or more investors via an online capital marketplace such as the marketplace 400 shown in FIG. 4. Accordingly, in step 501, a business owner initiates a potential transaction, generally via selecting an option such as “New Investment” on a web page provided to the owner by web server 410. Once a new investment opportunity is created in this way, in step 502 the owner may provide financial data about his company to marketplace 400. Examples of financial data that may be provided by owners include, but are not limited to, revenue and bookings, sales growth rates, gross margins, operating margins, cost of goods sold, commission costs, overall expenses broken down by categories such as sales, general, administration, research and development, marketing, and so forth. Data may be provided for current and past operating periods, which may be annual, quarterly, monthly, or any other periodicity (although typical embodiments may only request annual and optionally quarterly data from owners). In many cases, owners providing financial data will be providing unaudited data, although in some cases owners may have audited data to provide; in general online capital marketplaces 400 according to the invention will provide a means for owners to specify when they are providing audited financial data (and will typically then require that detailed information regarding who performed the audits be provided). Because companies being funded by marketplaces 400 according to the invention will be generally small and private, marketplace 400 may allow owners to enter whatever data is readily available to them when they initiate a potential investment transaction, and may require or request that the owner follow up to provide missing data elements. In general, certain data elements may be considered mandatory by marketplace 400, whereas other data elements (for example, detailed breakdown of expense categories) may be considered optional. In some embodiments, financial data provided in step 502 may be checked for internal consistency, and errors may be flagged by system 400 to call them to the attention of an owner entering data so that corrections may be made. Alternatively, consistency checks may be used as an input to one or more risk estimations carried out by data analysis and mining manager 420 (for example, if an owner provides very sketchy data that is not internally consistent, it may represent a “red flag” that financial management may be lax at the company, which would tend to make investments in the company more risky). Similarly, in some embodiments the existence of audited financial data may be considered in assessing a potential investment's risk profile (particularly if an optional verification step is provided so that marketplace 400 is enabled to independently verify such audited financial data).

Once an owner has provided financial data in step 502, in step 503 she may be requested or allowed to provide additional non-financial data that may be useful in classifying the business for which investment is sought. For example, various preconfigured data entry fields might be provided in a web page to allow an owner to select an industry to which the company in question belongs, to provide an SIC code, to select a company type such as “service”, “product”, “professional service”, or to select one or more characteristic markets to which the company sells (for example, “consumer”, “small business”, “local business”, “large enterprise IT”, etc.). Additional information may be provided as well (the examples just listed being exemplary and neither mandatory nor exclusive); for example, an address or a zip code may be provided in order to localize a company, a list of large clients could be provided, as well as for example data about number of clients, average client size, subscriber retention rates for subscription-based services, number of stores or outlets, and so forth. It should be evident to one having ordinary skill in the art that a wide range of data elements may be useful to marketplace 400 in classifying companies that seek investment, and potentially also to assess risk factors for such companies or investments. In step 504, owners may be requested or required to provide specific identifying data about the company for which investment is sought, as well as about one or more principals, shareholders, managers, or other stakeholders of the company. Such identifying information may be used by marketplace 400 to obtain additional data pertaining to one or more of the principals or other entities in order to corroborate or elaborate financial or other data provided by the owner in steps 502-503. In particular, in most cases marketplace 400 will require owners to grant authorization to the marketplace 400, in step 505, to undertake automated collection of tax and possibly other financial data (for example, credit histories or credit ratings of principals, shareholders, or managers). Authorization step 505 is important because tax data in particular is maintained as private data by government agencies, and in particular any non-governmental entity seeking access to such data must be explicitly authorized to do so by the affected taxpaying entity whose records are sought. Once authorization is successfully obtained, in step 506 marketplace 400 obtains tax and other financial data automatically. Use of tax return data for risk assessment, according to the invention, is advantageous at least because such data can be considered significantly more reliable than unaudited data and hence will generally be more reliable for due diligence and valuation purposes. Reliability of tax data results at least from the potential (well known to business owners) that the IRS or other government agency may audit tax records; and because, unlike self-reported financial data (such as revenue, where higher revenue leads to higher valuations), reverse incentives exist when reporting data to tax authorities (since overstating income has tax consequences). Hence tax return data may approach audited data for reliability.

In general, at least federal tax data will be obtained for relevant entities, such as the company itself, and any company shareholders, principals, managers, or other stakeholders whose financial data may be relevant in either validating financial data provided by the owner or in assigning a risk profile to a potential investment transaction in the company. In some cases, state tax data, or data from foreign or local governments or other taxing entities, may be obtained where available via electronic or online means. Additionally, in some cases credit data regarding relevant entities is also obtained, particularly to assist in the risk assessment process (for example, if a company's principal shareholder has a sterling credit history or credit rating, marketplace 400 may well reduce its assessment of the riskiness of a proposed capital transaction, whereas conversely a poor credit history or rating might lead marketplace 400 to assign a high level of risk to a proposed transaction, or even to refuse to allow a transaction. It will be appreciated by one having ordinary skill in the art that many types of financial or other risk-relevant data may be available online regarding relevant entities relating to a proposed capital transaction, any of which may be accessed with relevant authorizations to assist marketplace 400 in making sound risk assessments. In step 507, one or more key financial metrics or ratios may be computed in data analysis and mining manager 420 using the data obtained in steps 502-506, in particular owner-provided financial data and automatically obtained tax and other verified financial data.

There are many possible financial metrics or ratios known in the art that may be used to assess various aspects of a proposed capital transaction, any of which may be computed by data analysis and mining manager 420 according to the invention. For example, one or more ratios of various types such as leverage ratios (e.g., company debt divided by company equity), liquidity ratios (e.g., a ratio of cash and cash equivalents to total company assets), profitability ratios (e.g., a ratio of earnings before interest, tax, depreciation and amortization—EBITDA—divided by total company assets), debt coverage ratios (e.g., EBITDA divided by short-term liabilities), company solvency ratios (e.g., company value divided by company liabilities), and company activity-based ratios (e.g., the ratio of sales to total assets), may be computed by data analysis and mining manager 420. Moreover, various well-known financial metrics used by, for example, financial analysts to assess risk of various financial instruments associated with companies may be used according to the invention. For example, metrics such as a company's Z-score (a well-known derivative financial metric developed by Dr. Edward Altman, which attempts to estimate a probability that a given company will go bankrupt within the next two years) may be used in addition to various ratios such as those exemplary ratios listed above. It will be appreciated by one having ordinary skill in the art that many financial metrics and ratios are known in the art, any or all of which may be used according to the invention. For example, according to the invention various innovative risk models based on sophisticated mathematical algorithms derived from analyses of prior financial data, including for example (but not limited to) techniques based on logistical regression, support vector machines, or decision trees. In some cases, further data useful for assessing risk may be obtained in step 508 through searches of public databases or other data sources accessible online. For example, credit histories and ratings of relevant parties may be obtained, the existence of adverse or favorable court judgments regarding one or more relevant parties may be determined via a search of online court records, macroeconomic data or indicators may be obtained from a wide variety of sources, and so forth.

Armed with an array of risk-relevant data, in step 509 data analysis and mining manager 420 computes a plurality of risk indexes, risk profiles, and credit ratings for a prospective capital transaction. In some cases, a plurality of risk assessment and credit rating scores or metrics are combined to produce a base risk score for a potential transaction. Furthermore, when an overall borrowing level or range of such levels is specified (generally in step 501), a probability may be computed that the company in question would default on the proposed debt. This probability, optionally combined with some combination of risk or credit assessment metrics, may be used in conjunction with estimated recovery and loss rates in case of default to determine an initial set of deal parameters such as interest rate, conversion rate, and conversion maturity for the proposed deal. Then, in step 510, a report is prepared and may be presented to the requesting owner via a web page, a downloadable PDF report, or other suitable user interface means known in the art, to allow the owner to evaluate the desirability of proceeding with the proposed transaction. In some cases, an owner may opt to revise data previously provided (for instance, by providing financial data for more time periods, by adjusting a desired loan amount, or by otherwise amending deal parameters, such as by eliminating a low-credit party from the potential deal in order to improve the deal's attractiveness. Accordingly, in step 511 the process from step 502 to step 510 may be iterated as desired. Additionally, in some cases marketplace 400 might decide to iterate the process 500 itself, for example when a minimum period of time has elapsed after process 500 was initiated and a proposed transaction is not yet complete (in which case it may be desirable to obtain updated financial data from the owners and to recomputed the deal's risk profile).

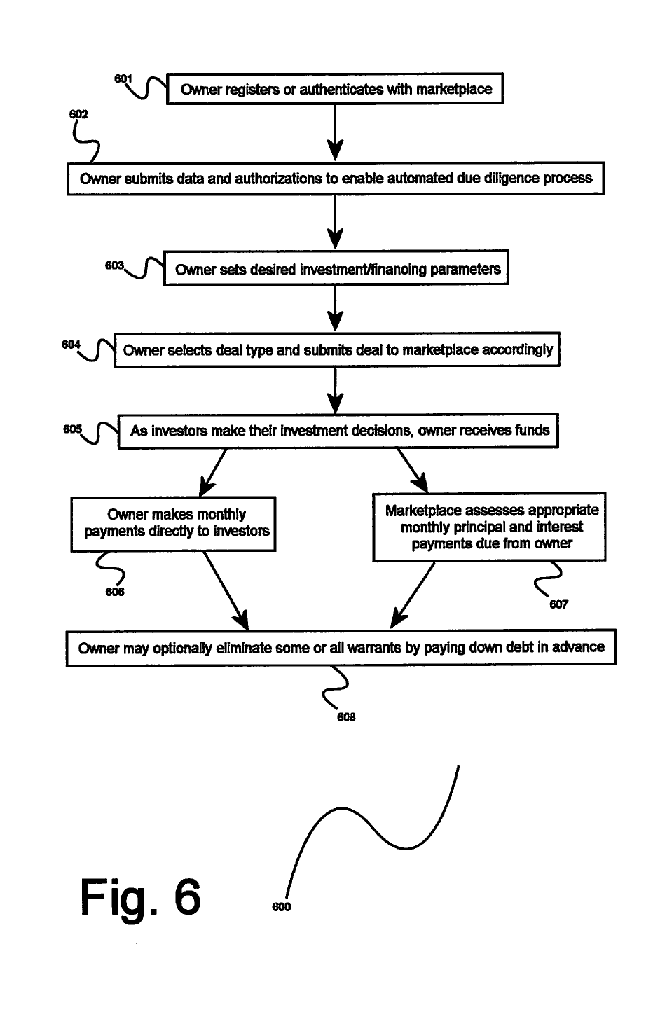

FIG. 6 is a process flow diagram illustrating an overall private company investment process 600 from the perspective of an owner, according to an embodiment of the invention. According to the embodiment, in step 601 an owner registers with marketplace 400 or, if already registered, authenticates with marketplace 400. Registration is a well-known process for online transactional systems, wherein a new registrant (in this case, a new owner) provides identifying information and generally provides a password or other token useful in future authentications. In many cases, registration may proceed in two or more steps, as when an email is sent to a new registrant to verify one or more of the registrant's email address, password, and the like. Once an owner is properly registered and/or authenticated, in step 602 the owner submits data and authorizations needed to enable marketplace 400 to carry out the automated due diligence process 500 described in FIG. 5. It is not necessary that all data is provided immediately; in some cases an initial data provision step is taken and the process continues, and then data may be iteratively added by the owner (or automatically obtained iteratively by marketplace 400). Furthermore, in some embodiments an owner may desire to wait before authorizing marketplace 400 to obtain sensitive data (e.g., tax data), until after the owner has for example been able to review prospective deal parameters (if an owner is unhappy with the parameters of deals she is likely to be able to make using marketplace 400, she may decide to abandon the process before having provided any sensitive tax data to marketplace 400). In step 603, the owner sets one or more desired investment or financing parameters to be used by marketplace 400 in structuring a proposed deal. Parameters established in step 603 may include, but are not limited to: details such as amount of capital to be raised in the proposed transaction; desired deal timing (for example, deal needs to be completed by a certain date, such as might be necessary if the owner is raising capital in order to pursue a time-limited growth opportunity); maximum monthly payments allowed (when specified by an owner, such a parameter may of course tend to limit the owner's financing opportunities); and so forth. In some cases, an owner may specify an overall aggregate index constraint on any prospective capital investment deal, and may authorize marketplace 400 to approve any proposed transactions that satisfy the aggregate index constraint without separate authorization from the owner. Such an aggregate index constraint is essentially a composite number that is computed from a proposed deal's interest rate, repayment length, conversion ratio, and conversion maturity; a valuable aspect of an aggregate index constraint is that it provides flexibility for marketplace 400 to adjust deal parameters to satisfy constraints of potential investors. As long as such adjustments result in an aggregate index value that continues to satisfy an owner's stated constraint, they may be made without requiring specific approval steps from the owner. For example, a particular investor may desire to lend money to a particular company, but he may believe that a proposed conversion ratio is too low (i.e., the investor values the company at a lower level than the owner does, and therefore would expect a higher equity stake in the event that conversion occurs, since the equity stake is determined by the owner's valuation); in such a case, marketplace 400 may, if an aggregate index constraint is specified, increase the conversion ratio while simultaneously adjusting for example the conversion maturity date (moving it later) or the interest rate to be paid by the owner (moving it downward) in order to maintain the aggregate index within the owner's stated constraints. Thus the use of an aggregated index constraint facilitates the automated and efficient creation of mutually satisfactory investments deals. Once an owner has specified the relevant financing parameters in step 603, in step 604 the owner may select a deal type and submit the deal to marketplace 400 for display to and consideration by a plurality of potential investors. Examples of deal types that may be available through marketplace 400 may include, but are not limited to: deals in which only one investor participates (in which case marketplace 400 attempts to identify an appropriate investor to act as the owner's counterparty); deals in which many investors can be syndicated into a single deal with one set of financial parameters (interest rate, conversions ratio, conversion maturity, repayment period, and the like); deals in which many investors may elect to invest, but each investor may invest using its own set of financial parameters, as long as they are approved by the owner or are within the owner's stated aggregate index constraint; or deals in which the owner's debt may be packaged with debt from a plurality of other companies into securities that are marketed and sold by marketplace 400 (in such deals, marketplace 400 may receive interest payments and make conversion decisions, with the aggregate proceeds—net management fees and profits retained by marketplace 400—being paid on a pro rata basis by marketplace 400 to each of the investors, who maintain an arms-length relationship with the plurality of owners to whom they have in effect loaned money); and so forth. Once an owner has made his selections in step 604, marketplace 400 interacts with investors to present proposed investment transactions, and as investors elect to make investments (or equivalently to loan money), in step 605 the investors make their independent investment decisions and the owner receives funds. Marketplace 400 may either incrementally satisfy an owner's borrowing needs, by providing funds immediately as each investor's transaction closes, or defer such satisfaction until sufficient required investment commitments have been made, providing complete funding in one transaction (moreover, other variations such as a hybrid between incremental funding and deferred funding, may be used). Once an owner has received funds from one or more investors, then one of steps 606 and 607 occurs. In step 606, an owner makes regular (monthly, quarterly, or according to any other schedule desired) payments directly to investors (payments will, as is usual in debt transactions, typically comprise a mix of interest and principal payments, although any payment schedule, payment order, or prioritization of obligations may be used according to the invention). In step 607, an alternative approach is used wherein marketplace 400 directly assesses appropriate monthly principal and interest payments from an owner (again, payments will typically comprise a mix of interest and principal payments, although any payment schedule, payment order, or prioritization of obligations may be used according to the invention). When step 607 is used, marketplace 400 will collect payments from owners and then pay creditors on a pro rata basis. A key potential difference between use of step 606 and use of step 607 concerns liability. Clearly, when step 606 is used, liability for non-payment of required payments would fall on the owner. On the other hand, when step 607 is used, it may well be that marketplace 400 is obligated to pay creditors regardless of whether or not an owner has previously paid its monthly bill to marketplace 400 (that is, marketplace 400 assumes liability for non-payment). However, it is envisioned by the inventor that various approaches may be taken when step 607 is used to allocate responsibility or liability for non-payment, and any such approach may be used according to the invention. It should be appreciated by one having ordinary skill in the art that various forms of risk allocation and legal liability assignment may be implemented according to the invention, without departing from the scope of the invention. Finally (from an owner's point of view), in step 608 an owner may at her discretion eliminate some or all outstanding warrants by paying down debt ahead of schedule (and particularly by doing so before an applicable conversion maturity date arrives, at which point investors may choose to convert and thereby remove the option from the owner).

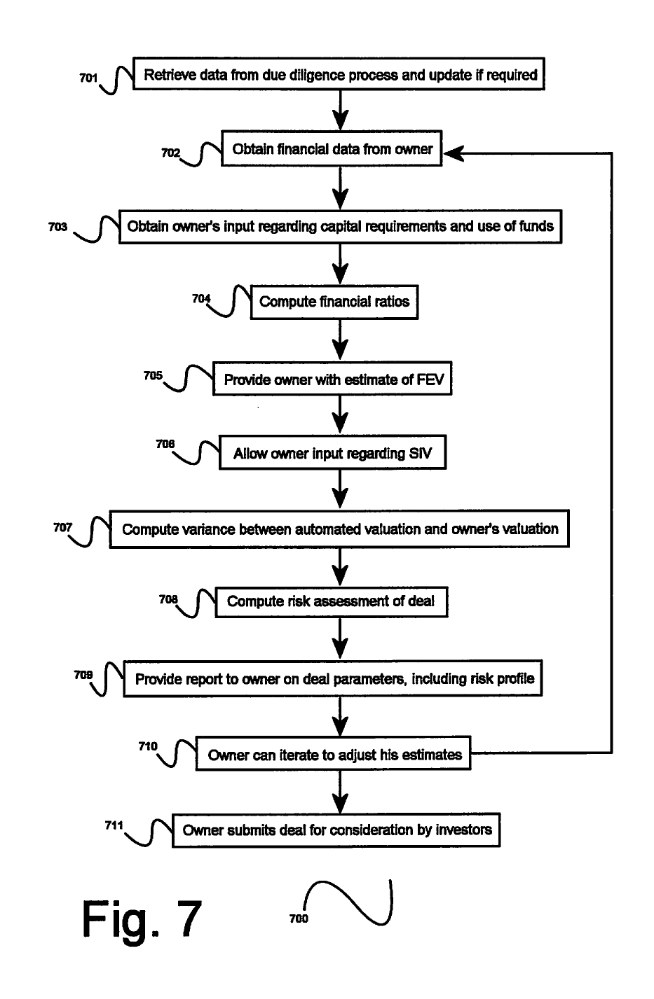

FIG. 7 is a process flow diagram illustrating an automated business valuation process 700, according to an embodiment of the invention. According to the method, in step 701 marketplace 400 retrieves data obtained or computed during automated due diligence process 500, and may update such data as required or desired (for example, if data was provided more than some preconfigured amount of time prior to initiation of process 700, a mandatory data refresh may be carried out by marketplace 400). Then, in step 702, system 400 contains financial data from the owner seeking investment in his private company (although it should be noted that step 702 may in some cases be omitted, where required financial data has already been obtained, for example through execution of the process of automated due diligence outlined above with reference to FIG. 5). In step 703, system 400 obtains from the owner input pertaining to the owner's capital requirements, and potentially also pertaining to the owner's (or the company's) planned use of any funds raised (it will be understood by one having ordinary skill in the art that one key factor in valuation of companies seeking capital is the purpose for which that capital is sought; for example, raising capital to pay off excessive debt will put a company in a better cash position but won't necessarily help it grow to capture a market opportunity, whereas a company raising capital to finance expansion in a growing market might represent a lower risk to potential investors). This information, as well as that obtained in step 702 and potentially information obtained during an automated due diligence process 500, is used to compute one or more financial ratios in step 704. Computation is typically performed by data analysis and mining manager 420, although it could be carried out by another component, or in parallel by several components. There are many possible financial metrics or ratios known in the art that may be used to assess various aspects of a proposed capital transaction, any of which may be computed by data analysis and mining manager 420 according to the invention. For example, one or more ratios of various types such as leverage ratios (e.g., company debt divided by company equity), liquidity ratios (e.g., a ratio of cash and cash equivalents to total company assets), profitability ratios (e.g., a ratio of earnings before interest, tax, depreciation and amortization—EBITDA—divided by total company assets), debt coverage ratios (e.g., EBITDA divided by short-term liabilities), company solvency ratios (e.g., company value divided by company liabilities), and company activity-based ratios (e.g., the ratio of sales to total assets), may be computed by data analysis and mining manager 420. Moreover, various well-known financial metrics used by for example financial analysts to assess risk of various financial instruments associated with companies may be used according to the invention. For example, metrics such as a company's Z-score (a well-known derivative financial metric developed by Dr. Edward Altman, which attempts to estimate a probability that a given company will go bankrupt within the next two years) may be used in addition to various ratios such as those exemplary ratios listed above. It will be appreciated by one having ordinary skill in the art that many financial metrics and ratios are known in the art, any or all of which may be used according to the invention. In some cases, further data useful for assessing risk may be obtained in step 508 through searches of public databases or other data sources accessible online. For example, credit histories and ratings of relevant parties may be obtained, the existence of adverse or unfavorable court judgments regarding one or more relevant parties may be determined via a search of online court records, macroeconomic data or indicators may be obtained from a wide variety of sources, and so forth. While many of the exemplary metrics just described are commonly used primarily for risk assessment, it should be clear that an equally wide array of commonly used financial metrics may be used to assess a company's present or future value; such metrics might include any of net sales, gross profit, EBITDA or EBIT, discretionary earnings, or book value, as well as SIC code and balance sheet data available on tax returns. Furthermore, according to the invention various multipliers may be computed, based on analyses performed using research data, and these multipliers may then be weighted and applied to create an FEV estimate.

In step 705, system 400 provides an owner with an estimate of his firm's fundamental economic value (FEV), which is a component of the overall value of the company that is determined solely by the company's objective historical financial performance, for example as compared to similarly situated (size, SIC code, etc.) companies. In particular, according to the embodiment data analysis and mining manager 420 may compare one or more of the ratios computed in step 704 against a plurality of similar ratios obtained from reported capital transactions (for example, mergers, acquisitions, announced stock purchases, venture capital funding events, and so forth) involving companies similar to the company being valued. “Similar to” as used here means that one or more key attributes of the company used for comparison with the owner's company is in a range that a person having ordinary skill in the art would consider “similar” to the same or an equivalent attribute of the target company (that is, the company whose owner is seeking to engage in a capital transaction using marketplace 400). Many attributes, or combinations of attributes, may be used to identify a plurality of similar companies to a given target company, including for example (but not limited to) market segment served, total revenue, revenue growth rate, type of company (product, service, cloud-based service, franchisor, etc.), or of course any of the ratios computed in step 704 (for example, a set of companies from the same or a closely related industry segment, of roughly the same size in terms of revenue, might be selected based on their having similar liquidity or profitability ratios). By comparing a target company with a plurality of similar companies, and particularly by taking into account one or more correlation factors between various attributes to identify companies that are particularly well suited for comparison against the target company, data analysis and mining manager 420 (or pricing manager 430 in some embodiments) may arrive at an estimate of the target company's FEV that may then be presented to the owner in step 705. It may often be the case than an owner will not agree with an estimated FEV reported in step 705, either because the owner unintentionally conflates his company's FEV with its total value (which also comprises at least a strategic investment value or SIV), or because the owner is privy to additional information that might influence a company's actual or estimated FEV and that might not have been provided (or provided fully) to marketplace 400. To accommodate such cases, in step 706 the owner may be provided an opportunity to provide additional input (i.e., data) regarding the strategic value of his company (that is, regarding SIV). While the owner may provide data relevant to SIV, in general the purpose of FEV is to provide a relatively objective and stable valuation that would apply to arms-length investors who derive little, if any, value from SIV or other factors. Accordingly, FEV will generally capture value relevant to arms-length investors in non-control positions; situations where SIV is relevant will be less common, according to the invention. Of course, in the same step the owner might be provided a means (for example, a web page with form elements for data input) to modify one or more of the inputs used to compute the FEV that was reported in step 705; it will be appreciated that many approaches to step 706 may be used to achieve the overall goal of allowing an owner to ensure that all material information has been provided to, and considered by, marketplace 400 in arriving at an estimated FEV for the owner's company. For example, the owner could be provided with an option to restart the entire process, or to provide additional financial or other business-relevant data, or to adjust or edit one or more data items that are already present in the system. It will not typically be desirable, however, to allow an owner to change data such as tax data that was obtained automatically (for example, via process 500) by marketplace 400; rather, an opportunity might be provided for an owner to note specific data automatically-obtained elements that he believes are likely erroneous, so that marketplace 400 may optionally follow up with the source of the contested data. Accordingly, it will be common for steps 705 and 706 to be performed more than once each for a potential transaction; at some point, though, the owner either agrees with or at least understands the reasoning behind the system-generated FEV reported in step 705 or “agrees to disagree” with the system-generated FEV.

In most cases, an owner's assessment of the value of his company will not agree with the estimated FEV arrived at by marketplace 400 and reported in step 705. Accordingly, in step 707 a variance between an automated FEV and an owner's valuation may be computed (in cases where an owner agrees with the FEV reported in step 705, this step could be skipped or automatically executed with a null result, since system-generated FEV and owner valuation would be substantially the same and the variance would be identically zero). In step 708, a risk assessment, or risk profile, for the deal is computed (generally by data analysis and mining manager 420).

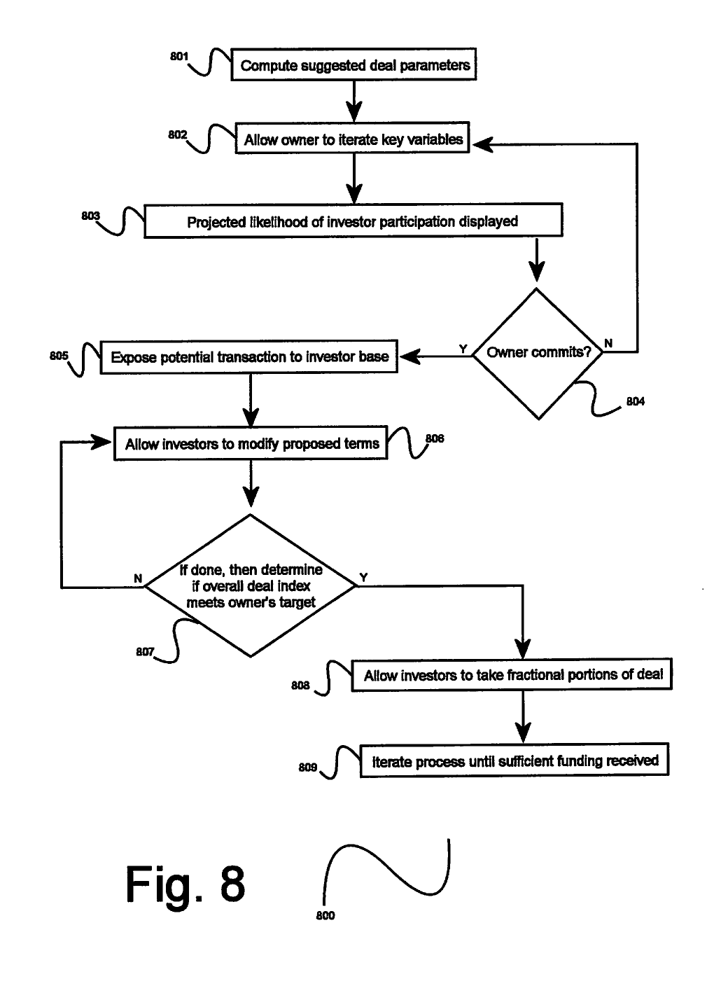

With a system-generated FEV and its variance from an owner's estimate of firm value in hand, as well as an automatically-generated risk profile, it is possible for marketplace 400 to generate a proposed capital transaction in which a hybrid security (described in detail below with reference to FIG. 8) is used to account for the differences between an owner's sense of his firm's value and an automatically-generated FEV of the firm (which, by the nature of FEV as defined herein, takes into account only financial measures that are independent of any specific strategic value the company might have, say, to a direct competitor as a potential acquirer), and to adjust the deal to account for the level of risk that will be undertaken by any investors who choose to purchase such hybrid securities. Parameters which may be varied by pricing manager 430 to achieve these goals may comprise (but need not be limited to) such exemplary parameters as deal size (number of preferred shares to be offered), share price of preferred stock, interest rate or yield on the preferred stock, conversion ratio and conversion maturity date for any warrants that will be issued with the preferred stock, and so forth. For example, if marketplace 400 determines that the size of capital transaction sought by an owner might make the deal highly risky, it might limit the number of shares to offer in order to mitigate that risk (this might be preferable to issuing the desired amount of preferred shares with a higher interest rate to reflect the increased risk, as for example when an owner has specified a maximum interest rate he is willing to consider). Once marketplace 400 has generated a proposed set of deal parameters, in step 709, a report is prepared for the owner that presents the deal parameters, optionally with explanatory text describing how the deal parameters were determined. In most cases, the report generated in step 709 will inform the owner of marketplace's 400 determination of attendant deal risks, for example by providing a risk profile for the prospective deal (and again, optionally presenting the owner with information describing various factors that contributed to the risk profile, so the owner may understand which aspects of his prospective deal are driving his borrowing costs up (since higher risk means generally a higher return must be provided to any investors willing to undertake the risk). As is generally the case throughout the various processes described herein, method 700 is inherently an iterative one, and accordingly in step 710 the owner may choose to iterate process 700 by for example returning to step 702 to change one or more parameters of the deal, for instance to lower desired capital to be borrowed in order to lower marketplace's 400 assigned risk profile for the deal (it should be noted that various points of return to method 700 may be used when an owner chooses to iterate in step 710; step 702 is shown merely as an exemplary reentry point in method 700). At any point in method 700, an owner might decide to abandon his prospective deal, for example because the cost of capital is too high (for example because marketplace 400 assesses deal risk as high). Such premature departures are not shown in FIG. 7, and could occur anywhere. Barring such an exit, though, once an owner is satisfied with a proposed deal, he passes step 710 and proceeds to step 711, where he may confirm his acceptance of proposed deal parameters, and where he may thereupon (optionally) submit the deal for presentation by marketplace 400 to prospective investors, who may in turn consider the deal and optionally invest.

FIG. 8 is a process flow diagram illustrating a process 800 for creating a hybrid security for private capital transactions, according to an embodiment of the invention. According to the embodiment, in step 801 marketplace 400 computes deal parameters, for example as described above with reference to FIG. 7. Then, in step 802, the owner is allowed to iterate key variables (analogous to what was described above, for example with reference to step 710), and after each iteration, marketplace 400 may display, in step 803, a likelihood of investor participation in the deal as currently proposed. In step 803, marketplace 400 may also display various indicia of projected impacts of various changes made by the owner, or of various deal parameters. For example, in various embodiments, an owner may be provided with a graphical element in a user interface, such as a slider bar (such elements are well known in the art), to allow an owner to dynamically or interactively iterate various parameter combinations to substantially immediately receive feedback on how each change is likely to affect investor participation, interest rates, conversion ratios and maturities, and other relevant deal parameters. In this way an owner may be provided tools to facilitate to fully explore a space of potential deals in order to find or derive a set of deal parameters that are satisfactory to the owner. Either in a separate confirmation step after each iteration of deal parameters, or as a continuously available interface element that an owner may choose to use at any time, in step 804 a check is made to see whether the owner is willing to commit to a deal with a current set of deal parameters. If the owner chooses not to commit, execution returns to step 802; if on the other hand the owner chooses to commit to a current proposed deal, then in step 805 marketplace 400 exposes the deal to a plurality of potential investors.

One important aspect of the present invention is the application of automated intelligence to the selection of investors to whom to show potential deals. If every potential capital transaction were shown to every potential investor, regardless of any degree of “fit” between a specific investor and a specific deal, marketplace 400 would likely be unresponsive to investors' and owners' needs. Investors want to be shown deals that are likely to interest them, based on their investment profile (for example, private equity investors typically have a well-defined range of deal sizes and financial deal aspects within which they operate, and would not be willing to even consider deals outside these ranges), and might well be frustrated if they were presented large numbers of irrelevant deals. In various embodiments, the inventors envision several different approaches to this problem, any of which may be used according to the invention in any particular embodiment. For example, in some cases investors are provided with a search capability that allows them to search for particular types of deals in the system that have been approved for investor review or participation (that is, that have passed step 804 with a positive result), while in other cases investors may be provided with a filtering style user interface, where they are enabled to “filter out” undesirable classes of deals (for example, all deals where less than a million dollar investment is being sought by an owner). In other variations, investors may specify one or more desirable deal parameters, and then allow the system to recommend deals that it determines represent a likely fit for the investor's stated investment goals or interests (and possibly for one or more unstated goals or investment profiles, as for example when data analysis and mining manager 420 analyzes historical data pertaining to an investor's interactions with marketplace 400, such as what kinds of deals were viewed, what kinds were invested in, and which kinds had a higher-than-average view-to-deal conversion rate). It should be appreciated by one having ordinary skill in the art that there are many query, search, filter, and recommendation mechanisms known in the art generally, any of which may be used by marketplace 400 to bring a useful selection of potential deals in front of a particular investor, without departing from the scope of the invention.

When an investor has been presented a deal in step 805, she might be interested in the company seeking investment, but might not prefer the particular set of deal parameters currently on offer from marketplace 400. In this case, in step 806, the investor may be allowed to modify one or more deal parameters or proposed deal terms. Such modifications may be prohibited by an owner (for example, by expressing a preference that “no deal modifications are allowed” in step 703 or an equivalent step), or may be prohibited by marketplace 400 (as, for example, when “new” investors with less than some minimum level or number of completed investment transactions, are limited to a “take it or leave it” mode to prevent unnecessary churn in the system from inexperienced investors). Furthermore, even when deal modifications are allowed, they may be limited in one or more ways. For example, in some embodiments, one or more aggregate deal indexes (such as an aggregate price index) may be developed based on parameters such as minimum investment amount per investor, interest rate, share price, warrant conversion ratio, and warrant conversion maturity, in order to allow marketplace 400 to accept one or more aggregate deal index constraints from an owner in terms of the one or more aggregate deal indexes, and to allow one or more investors to vary one or more of the parameters as desired to align the total risk profile and returns to their investment strategy. According to such embodiments, changes proposed by investors will be accepted if they result in an aggregate deal index that remains consistent with any constraints made by the relevant company owners. When investors do modify deal terms in step 806, then in step 807 a determination is made whether the changes proposed by the investor are acceptable or not. In some cases, this is done by actively querying the relevant owner to obtain her explicit approval for the modified deal. In other cases, particularly in cases where owners have stated one or more aggregate deal index constraints, a check is made to determine whether the modified deal still meets any stated aggregate deal index constraints (“still” because deals that didn't meet such constraints as originally constructed would not have been displayed to investors). If a proposed deal modification is determined to be unacceptable, by whatever means, then the method returns to step 806 (unless the investor in question simply abandons the deal, which she may do at any point in the process, just as an owner may abandon a proposed deal at any point until she commits to a proposed deal). If the modified deal is acceptable, then in step 808 the investor is allowed to take all or fractional portions of the deal (that is, to make a commitment to invest either everything sought by an owner, or some portion thereof). It should be noted that not all investors will make deal modifications; when an investor is satisfied with a proposed deal, she may move directly from step 805 to step 808 (transition not shown). In step 809, the process is repeated or iterated as necessary until sufficient funding is received to satisfy an owner's fund raising objectives. Of course, in some cases an owner may not receive as much funding as desired, and in other cases marketplace 400 might, if a particular investment opportunity generates strong investor demand, propose an expansion of the investment opportunity to the owner. Also, as noted before, in some cases an owner might specify an “all or nothing” deal in which a single investor must provide all or some minimum portion of the funding desired, and no other investors would then be allowed to invest in the deal. In yet other cases, an owner or marketplace 400 might specify that all deals, or some specific deals, or some specific class or type of deals, remain unfunded until fully subscribed, rather than being incrementally funded as investors commit (this might occur, for example, for certain deals marketplace 400 determines are exceptionally high risk, or when an owner makes the stipulation to avoid entering into any investment arrangement unless some minimum total investment level can be achieved). It will be appreciated by one having ordinary skill in the art that a wide range of constraints on exactly how and when deals are funded or transactions are committed (the parties thereto thereby becoming legally bound to each other); such variations would typically be accommodated as configurable parameters of any given deal, and do not depart from the scope of the invention as claimed.

Importantly, various techniques disclosed in the previous paragraph are illustrative of a general category of techniques that are important, according to the invention, that pertain to the maintenance of a certain “tension” between the interests of owners and investors. Such tension is necessary for effective markets to exist; if system 400 were designed to take owners' interests into account exclusively, for example, then there would be few investors and the actual goals of owners—to raise capital—would be frustrated. Similarly, if investors' interests were given too much weight, the opposite would occur, and again an insignificant level of actual market activity would likely ensure. Only by maintaining a degree of tension between owners' interests and those of investors will system 400 be able to create a functioning market.

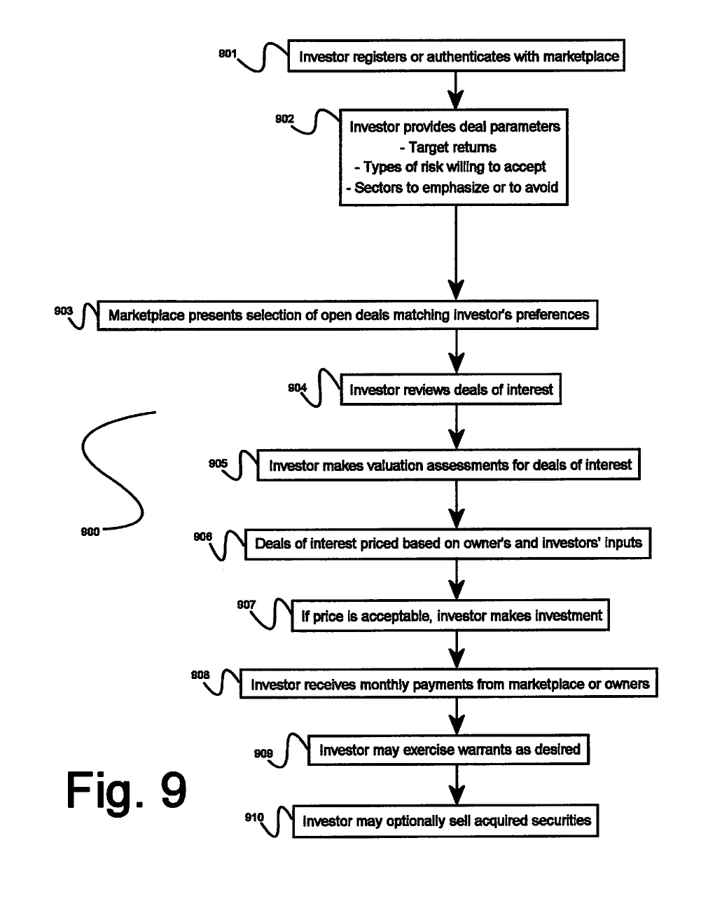

FIG. 9 is process flow diagram illustrating an overall private company investment process 900 from the perspective of an investor, according to an embodiment of the invention. According to the embodiment, in step 901 an investor either registers or authenticates with marketplace 400. Typically, when an investor first connects to marketplace 400 via an online interaction means (typically, but not necessarily, a web browser), the investor it provided an opportunity to register with marketplace 400, using registration techniques that are well known in the art (for example, providing a valid email address, a full name and address, a working phone number, and some sort of identity verification, such as a set of credit card data). Once an investor is registered, then in step 901 the investor would, when returning to marketplace 400 (for instance, when visiting its web site, although “returning” could also mean accessing one or more features of marketplace 400 via a remote method invocation technique known in the art, such as a web services call). In some embodiments, a previously registered investor may be identified through use of a cookie or other persistent means capable of identifying either the investor or a device uniquely used by the investor (for example, another means might be to use one or more biometrics techniques known in the art). In such cases, typically a final verification might be used, such as a secret question or a captcha (to guard against automated impersonation of investors or other users); such additional means may be invoked selectively based, for example, on a length of time since the investor's last visit, or on an automated verification that the investor is connecting from one or more devices known to be closely associated with the investor.

Once an investor is properly allowed access to the system (in step 901), in step 902 the investor may provide one or more deal parameters, expressing thereby her preferences in terms of deals in which she is likely to seriously consider investing. In some embodiments, investors may be allowed to establish default preferences that, absent being overridden during a particular session, will be used automatically when selecting deals for presentation to an investor. There are of course many kinds of deal parameters or deal preferences that an investor might specify; typical examples may comprise target returns of prospective investments, types and levels of risk the investor is willing to consider taking, and sectors in which the investor may prefer to focus her investment, or which the investor may prefer to avoid altogether (for example, many investors pursue sector diversification strategies, or focus only on a small set of industry sectors, or may explicitly avoid investing in newer or more speculative sectors such as nanotech, renewable energy, or commercial space exploration). Alternatively, investors may elect at any time to carry out step 902 using a more typical search-engine or filtering approach. For example, an investor may express a search query, such as “enterprise software seed”, thereby telling system 400 that she wants to review a list of potential investments that contain or are related to those keywords. Similarly, an investor may elect to state certain filtering options, such as “only deals under $1 million,” “no companies with less than one year of revenue records”, “profitable software companies”, and the like. It should be evident to one having ordinary skill in the art that many approaches have been taken in the art of information retrieval, any of which (or indeed any combination of which) may be used according to the invention to specify selection criteria for prospective investments to be shown to a particular investor at a particular time. Once such criteria have been expressed (keeping in mind that open-ended criteria such as “show me everything” or “I'm feeling lucky!” are also variants that could be used in step 902), in step 903 marketplace 400 presents a selection of one or more open deals matching those criteria. Then, in step 904, the investor may review one or more, or all (or none; for example, the investor could choose to leave, or to repeat step 902 with different selection criteria) of the prospective deals displayed. Typically, an investor will be provided with various tools for reviewing prospective investments, comprising for example clickable links for each investment opportunity that take the investor to more detailed screens focused solely on a particular investment or set of related investments. It should be evident to one having ordinary skill in the art that many approaches to enabling a user to select a plurality of search results (i.e., prospective investments) and to “drill down” or “drill into” the selected results are known in the art, any of which may be used according to the invention. Once an investor has selected one or more deals of particular interest, in step 905 he may be provided an option to express his own valuation assessment of some or all of the deals in which he is interested. For example, an investor might conclude that an owner's revenue targets for the next three years are overly ambitious, and may prefer to consider an investment based on what he believes to be a more realistic revenue model. In various embodiments of the invention, an investor may be allowed to change different deal parameters or combinations of deal parameters. For example, in some embodiments, an investor may only be allowed to express a valuation that he considers appropriate for the target company. In another embodiment, an investor might be allowed to modify projected revenue numbers, or to apply a discount factor to such numbers (this actually might be preferred, since the underlying parameter is unchanged and therefore it will not be necessary to store multiple versions of it, each of which would have to be changed when an owner provides changed or updated data). In yet another embodiment, an investor might simply be allowed to specify certain facts or parameters of a deal for exclusion by marketplace 400 when computing any actual deal pricing. In various embodiments, investors may be allowed to change one or more of interest rate to be paid on preferred shares, conversion ratio to be applied to warrants, warrant maturity dates, and the like, in order to cause deal valuation to be adjusted accordingly. Of course, if such an adjustment ultimately leads to a deal's failing to meet an owner's aggregate index constraint, then the particular deal would not be available as an investment opportunity for that investor.

Once an investor has expressed interest in one or more particular investment deals, and optionally has made any changes to deal parameters or expressed any deal constraints, in step 906 pricing manager 430 computes an appropriate deal price, if possible. “Deal price” generally means a plurality of specific price-related deal parameters, such as price per preferred share, number of preferred shares, interest rate to be paid on preferred shares, conversion ratio and maturity dates for any warrants to be issued with preferred shares as part of a hybrid security, and so forth. Pricing is not always possible, of course; for example, if an investor makes certain adjustments or establishes certain deal constraints that are incompatible with one or more owner constraints, or if an aggregate effect of investor-specified changes pushes a deal outside of an owner's stated aggregate index constraints, then the deal as proposed would not satisfy either the owner's requirements or the investor's requirements (or, indeed, it could fail to satisfy any parties' requirements and thus be satisfactory to no one). In such cases, marketplace 400 may notify either or both of the relevant owners and investors, and may allow an investor to return to step 904 or step 905, or alternatively may allow an owner to adjust his deal parameters by allowing him to return to step 802, for example. When a mathematically feasible price is established in step 906 (“mathematically feasible” here meaning that a proposed price does not violate any hard constraints established by any of the owners or investors, or by marketplace 400 itself), then in step 907 the investor may elect, if the price is acceptable (it may have been modified in step 906 from his preferred parameters set in step 905), to make all or some portion of the proposed investment. If such an election is made, then as part of step 908, marketplace 400 carries out a transaction confirmation and commitment process, essentially analogous to any number of purchase commitment or purchase transaction processes known in the art of online purchasing or online brokerage (for example, in some embodiments, various credit checks and regulatory compliance checks may be carried out before an investment transaction is committed and becomes binding; in other embodiments such checks might be performed prior to step 908). According to various embodiments of the invention, each of a plurality of investors may engage in transactions regarding a particular entity desiring investment using its own set of deal parameters, such that the entity's aggregate investments received may occur with various deal parameters rather than one single set of deal parameters for all investors; conversely, in various embodiments a plurality of investors may collectively agree to a single set of deal parameters and therefore engage in a plurality of separate investment transactions, each of which is based on the same one set of deal parameters. It will be appreciated by one having ordinary skill in the art that various possibilities other than the two endpoints just described may be used according to the invention (that is, some groups of investors may use a common set of deal parameters for a particular deal, while other investors or groups of investors may have different deal parameters). Once an investment transaction has been committed and closed (meaning the investor has purchased actual investment instruments such as the hybrid security referred to above with reference to FIG. 8, and has thereby provided funds to the company seeking investment and received preferred shares and warrants in said company), in step 908 the investor regularly receives interest payments from either marketplace 400 or the company in which she invested (or its owners). Usually, interest payments are made monthly, although payments of any periodicity, such as quarterly, may be specified as part of any particular deal's specifics. Payment of interest and handling of default situations proceeds as per the normal course of business for credit transactions between investors and companies. In various embodiments, interest payments may be collected by marketplace 400 and then distributed proportionally to individual investors, or investors may receive interest payment directly from the companies they invested in. Moreover, in some cases marketplace 400 may make the actual investments in private companies, doing so on behalf of investors who have elected to allow marketplace 400 to carry out this function; in such embodiments, marketplace 400 would be the beneficial owner of the shares, and would exercise for example any conversion rights in the interests of itself and its aggregate population of investors. Once any specified maturity dates for warrants issued in step 908 pass, investors may elect, in step 909 to exercise some or all of any warrants they hold, thereby converting their preferred shares into common shares (and foregoing future interest payments on the converted preferred shares, as the investment would thereby be converted into a pure equity investment). Finally, subject to any state or federal regulations or any contractual limitations imposed on private investors in a company (such limitations are commonly included as part of an investment's offering memorandum and any resulting binding contracts), investors may elect in step 910 to sell some or all of the shares (whether preferred or common) or warrants in the company in which they invested to other investors (including possibly to the company itself).

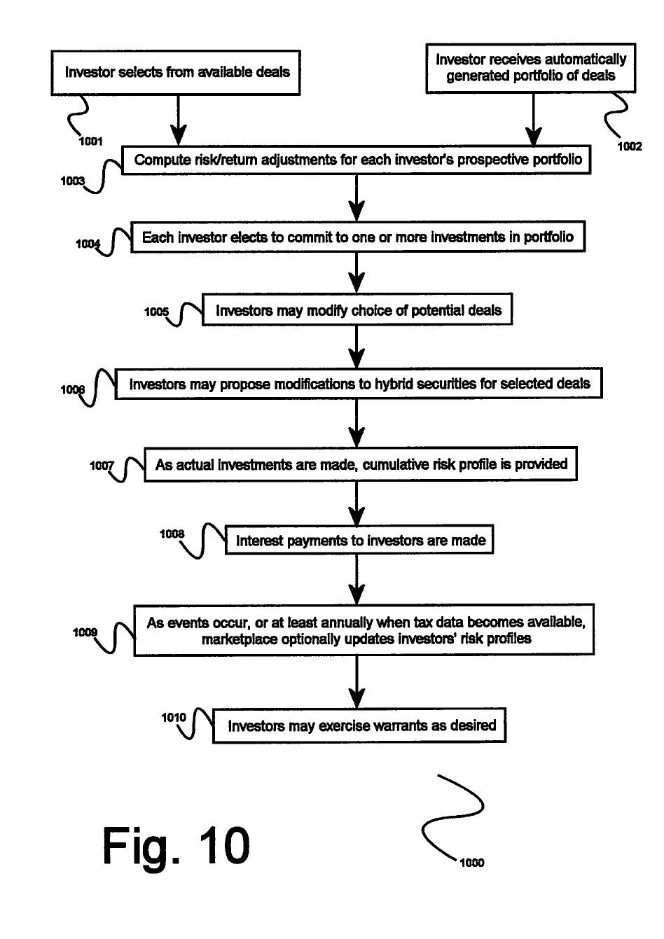

FIG. 10 is a process flow diagram illustrating a process 1000 for portfolio diversification using fractionalized lending, according to an embodiment of the invention. Diversification is of course a very common means for investors to maximize the ratio between returns received and risks incurred in investing, primarily by minimizing the likelihood of an entire investment portfolio's being adversely impacted by a single company-related or market-related event. The principle of diversification in general is well understood in the art and will not be further addressed here; rather, the focus of what follows is on how to enable better pursuit of diversification strategies when investing in small privately held companies. This has historically been one of the obstacles of such investing since companies typically have been limited in the number of investors they can reach accommodation with (both for regulatory and practical reasons). Advantageously, investors are allowed, via services of marketplace 400, to make fractional investments in a wide variety of small privately held companies without having to incur the high costs of performing due diligence on each company themselves, thus participating in a wider range of deals while mitigating risk through diversification. According to the embodiment, investor diversification through fractionalized lending can commence either as an investor selects from available deals (step 1001), or via an investors receiving, from marketplace 400, an automatically-generated proposed portfolio of deals (step 1002). Automatic generation of diversified portfolios may be performed by marketplace 400 to leverage the availability to marketplace 400 of extensive historical data on similar private company investment transactions to further reduce both the risks and costs associated with making a large number of private capital investments. For example, various portfolios generated automatically by marketplace 400 might follow one or more key themes (for instance, a geographically- and sector-mixed technology company portfolio), or might be based on a quantitative optimization function (as for example when sectors and companies are selected that have negatively correlated risks—for example by combining several companies dependent on the normal business cycle for profitability with several companies that are countercyclical in that they tend to perform well when the business cycle is down). Once an investor has a candidate portfolio in mind (as a result of either or both of steps 1001 and 1002, which may be iterated to achieve a portfolio of interest to an investor), in step 1003 marketplace 400 (for example, by use of data analysis and mining manager 420, although pricing manager 430 might also be used for this purpose, according to the invention) computes an estimated aggregate return and risk profile for each candidate portfolio being considered by each investor (of course, these steps can be taken one portfolio—investor pair at a time as well). In step 1004, each investor may optionally commit to one or more investments in a portfolio, which may in turn modify the portfolio's expected risk and return profile. Not all deals in a portfolio may be committed to (or rejected) in step 1004; indeed, in many cases steps 1003-1007 may be made multiple times, in various orders, as various investors consider, refine, and make diversified investment decisions). Then, in step 1005, investors may modify their choices of potential deals, adding more committed investments as desired (and possibly removing some prospective deals entirely from one or more portfolios being considered). In step 1006, investors may also elect to propose one or more modifications to various parameters to hybrid securities proposed for one or more prospective investments. As discussed variously above, such adjustments may for example comprise changes to one or more of interest rates associated with preferred shares, preferred share prices per share, warrant conversion ratios and maturity dates, and so forth. As each investment decision is made, in step 1007 marketplace 400 may provide applicable investors with updated risk and return profiles based on the changes to affected portfolios. In this way, investors are not forced to make an “all-or-nothing” diversification decision, but may incrementally adjust a particular portfolio, receiving correspondingly incremental feedback regarding the risk profile and likely returns of the portfolio after each such adjustment. Moreover, adjustments and decisions in steps 1004 through 1006 may not always or even typically be irrevocable; for example, an investor may provisionally select certain investments in order to assess an overall diversification approach, then modify it incrementally, and finally make committed, binding transactions once a satisfactory portfolio performance level is achieved. Once a diversified portfolio is established (even if it is still being refined, as long as some investments have actually been made), in step 1008 interest payments are made to investors as corresponding funds are received from companies or their owners. As discussed above, actual ownership of any preferred shares and warrants may be taken by marketplace 400 on behalf of a syndicate of investors, or directly by investors, as desired. In step 1009, as events occur (such as acquisitions, regulatory submissions, announced deals, and so forth), marketplace 400 may evaluate newly received data about a plurality of private companies in which fractional lending transactions have been executed as part of a diversified investment portfolio in order to determine one or more updates to a portfolio's estimated future returns and its risk profile. Such modified risk/return assessments will typically be made at least annually, as companies' tax data is updated following their filing of annual tax returns (which would be received automatically based on the owner's prior authorization, as discussed above with reference to FIGS. 4-5). Then, in step 1010, investors (or marketplace 400, if appropriate) may elect to exercise some or all of any warrants they hold in one or more private companies within a diversified portfolio, in order to maximize their overall return.

Additionally, in some embodiments systems according to the invention are provided as cloud-based platforms that are accessible to and usable by a wide range of users, potentially from any number of distinct enterprises or other organizations. In such embodiments, active rich security models described above are particularly important, as users from various organizations will require access to different items, and with different degrees of freedom, dependent on business needs of the relevant organizations. According to such embodiments, access to capabilities of platforms operating in accordance with the invention may be provided through human user interfaces such as browser-based document submission and retrieval applications, but also and more generally through any suitable data interface means known in the art. Examples of such data interface means may comprise, but are not limited to, application programming interfaces (APIs), purpose-built and/or customized tools adapted to enable programmatic access for example to expanded private capital markets database 421, web services accessed via an application server or a web server, Java remote method invocations, and so forth. Using such access means, third parties may be able, according to some embodiments, to build independent applications that interface with and make use of the capabilities of systems designed in accordance with the invention. In some embodiments, a plurality of such third-party applications may be made available, under suitable commercial terms, via an application store that specializes in providing access to applications designed to make use of the invention.

The skilled person will be aware of a range of possible modifications of the various embodiments described above. Accordingly, the present invention is defined by the claims and their equivalents.

What is claimed is:

1. A system for issuing a hybrid structured preferred security within private capital markets comprising:
an application server computer connected to a data network;
a data analysis manager software module operating on a server computer;
an automated due diligence manager software module operating on a server computer;
an automated pricing manager software module operating on a server computer;
a transaction manager software module operating on a server computer; and
a plurality of data collection servers adapted to retrieve via the Internet financial data pertaining to a prospective capital transaction from a plurality of remote data sources comprising at least a remote electronic tax data retrieval system operated by a taxing authority;
wherein, upon receipt by the application server of a request for initiation of a new prospective capital transaction by an entity seeking investment, the application server sends a plurality of data entry forms to the entity and receives as a result a plurality of data elements pertaining to the entity or the prospective capital transaction and an automated due diligence process is conducted by the automated due diligence manager using at least tax data retrieved from at least one remote electronic tax data retrieval system;
wherein, using a plurality of results from the automated due diligence process and a plurality of analyses of historical data pertaining to other entities and their capital transactions, the data analysis manager computes one or more risk parameters pertaining to the prospective capital transaction;
wherein the automated pricing manager computes, based at least on a risk parameter computed by the data analysis manager, a plurality of deal parameters comprising one or more of an interest rate for a preferred equity, a conversion ratio for a detachable warrant, a maturity date for conversion of the warrant, and a share price of the preferred equity;
wherein the application server sends the plurality of deal parameters to the requesting entity, receives an indicia of acceptance of the plurality of deal parameters from the requesting entity, and thereupon makes the plurality of deal parameters available for review by a plurality of potential investors via the Internet; and
wherein, on receiving from an investor an acceptance of a plurality of final deal parameters and an amount to be invested, the transaction manager verifies that the final deal parameters satisfy one or more constraints provided by the requesting entity, and if the verification is successful issues a plurality of hybrid securities to the investor equivalent to the amount to be invested, each hybrid security comprising a preferred equity share with an interest rate and a detachable warrant to purchase a number of common shares at any time after a specific maturity date, the number of common shares determined by a specific conversion ratio.

2. The system of claim 1, wherein the plurality of data elements comprises at least an authorization to obtain online tax records pertaining to one or more of the entity and a plurality of its principals.

3. The system of claim 1, wherein a plurality of investors each lend a fraction of a total investment amount requested by an entity requesting capital.

4. The system of claim 3, wherein each of the plurality of investors invests using its own specific set of deal parameters.

5. An online private capital marketplace, comprising:
a plurality of application server computers connected to a data network;
a data analysis manager software module operating on a server computer;
an automated due diligence manager software module operating on a server computer;
an automated pricing manager software module operating on a server computer;
a transaction manager software module operating on a server computer; and
a plurality of data collection servers adapted to retrieve via the Internet financial data pertaining to a prospective capital transaction from a plurality of remote data sources comprising at least a remote electronic tax data retrieval system operated by a taxing authority;
wherein the marketplace receives, at the plurality of application servers, requests from investors seeking to make investments in private companies and owners seeking to raise capital, and upon receiving a request from an owner obtains data relevant to the request from the owner, the data comprising at least an authorization for the marketplace to obtain online tax records pertaining to the owner;
further wherein, upon receiving the authorization, the marketplace conducts an automated due diligence process is conducted by the automated due diligence manager using at least tax data retrieved from at least one remote electronic tax data retrieval system;
wherein, using a plurality of results from the automated due diligence process and a plurality of analyses of historical data pertaining to other entities and their capital transactions, the data analysis manager computes one or more risk parameters pertaining to the prospective capital transaction;
wherein the automated pricing manager computes, based at least on a risk parameter computed by the data analysis manager, a plurality of deal parameters comprising one or more of an interest rate for a preferred equity, a conversion ratio for a detachable warrant, a maturity date for conversion of the warrant, and a share price of the preferred equity;
wherein the application server sends the plurality of deal parameters to the requesting entity, receives an indicia of acceptance of the plurality of deal parameters from the requesting entity, and thereupon makes the plurality of deal parameters available for review by a plurality of potential investors via the Internet; and
wherein, on receiving from an investor an acceptance of a plurality of final deal parameters and an amount to be invested, the transaction manager verifies that the final deal parameters satisfy one or more constraints provided by the requesting entity, and if the verification is successful issues a plurality of hybrid securities to the investor equivalent to the amount to be invested, each hybrid security comprising a preferred equity share with an interest rate and a detachable warrant to purchase a number of common shares at any time after a specific maturity date, the number of common shares determined by a specific conversion ratio.

6. The marketplace of claim 5, wherein the marketplace assembles a plurality of investors each making a fractional capital contribution to a specific transaction, thereby spreading the costs of due diligence and transaction execution for a private capital transaction among a plurality of investors.

7. The marketplace of claim 5, wherein the marketplace assembles a plurality of investment opportunities into a portfolio with a low overall risk computed by the data analysis manager, and offers the portfolio as a unitary diversified investment vehicle to a plurality of investors.

8. The marketplace of claim 5, further comprising a means for investors to sell existing preferred securities or detachable warrants to other investors or to the marketplace itself.

9. A method for issuing a hybrid structured preferred security within private capital markets, the method comprising the steps of:
(a) receiving, at an application server, a request for initiation of a new prospective capital transaction by an entity seeking investment;
(b) sending, by the application server, a plurality of data entry forms to the entity;
(c) receiving, at the application server, a plurality of data elements pertaining to the entity or the prospective capital transaction;
(d) conducting an automated due diligence process by an automated due diligence manager using at least tax data retrieved from at least one remote electronic tax data retrieval system;
(e) computing, using a data analysis manager software module, one or more risk parameters pertaining to the prospective capital transaction using a plurality of results from the automated due diligence process and a plurality of analyses of historical data pertaining to other entities and their capital transactions;
(f) computing, using an automated pricing manager software module, based at least on a risk parameter computed by the data analysis manager, a plurality of deal parameters comprising one or more of an interest rate for a preferred equity, a conversion ratio for a detachable warrant, a maturity date for conversion of the warrant, and a share price of the preferred equity;
(g) sending the plurality of deal parameters to the entity;
(h) receiving an indicia of acceptance of the plurality of deal parameters from the entity;
(i) making the plurality of deal parameters available for review by a plurality of potential investors via the Internet;
(j) receiving from an investor an acceptance of a plurality of final deal parameters and an amount to be invested; and
(k) upon verification by a transaction manager software module that the final deal parameters satisfy one or more constraints provided by the requesting entity, issuing a plurality of hybrid securities to the investor equivalent to the amount to be invested, each hybrid security comprising a preferred equity share with an interest rate and a detachable warrant to purchase a number of common shares at any time after a specific maturity date, the number of common shares determined by a specific conversion ratio.

10. The method of claim 9, wherein the plurality of data elements comprises at least an authorization to obtain online tax records pertaining to one or more of the entity and a plurality of its principals.

11. The method of claim 9, wherein a plurality of investors each lend a fraction of a total investment amount requested by an entity requesting capital.

12. The method of claim 11, wherein each of the plurality of investors invests using its own specific set of deal parameters.
